(19) United States
(12) Patent Application Publication
(10) Pub. No.: US 2026/0117807 A1
(43) Pub. Date: Apr. 30, 2026

(54) BED WITH CONNECTORS

(71) Applicant: Sleep Number Corporation, Minneapolis, MN (US)

(72) Inventor: Bruce William Gaunt, Albertville, MN (US)

(21) Appl. No.: 19/369,453

(22) Filed: Oct. 27, 2025

Related U.S. Application Data
(60) Provisional application No. 63/712,898, filed on Oct. 28, 2024.

(51) Int. Cl. F16B 5/06; A47C 21/00

(52) U.S. Cl. CPC F16B 5/0621; A47C 21/00

(57) ABSTRACT

Bed systems include a mattress that is configured to be attached to a foundation. The bed systems include a mattress attachment mechanism that connects the mattress and the foundation to each other. The mattress attachment mechanism includes a first connector that includes a clamp flange and a second connector that includes a clamp and a clamp actuator.

### CROSS REFERENCE TO RELATED APPLICATIONS

This application claims priority to U.S. Application Serial No. 63/712,898, filed on October 28, 2024. The disclosure of the prior application is considered part of the disclosure of this application and incorporated in its entirety into this application.

### BACKGROUND

In general, a bed is a piece of furniture used as a location to sleep or relax. Many modern beds include a soft mattress on a bed frame or foundation that supports the mattress. The mattress may include springs, foam material, and/or an air chamber to support the weight of one or more occupants.

### SUMMARY

Some implementations described herein include systems and methods related to consumer devices such as beds that include one or more attachment mechanisms to connect a mattress to a foundation. For example, a bed system can include a plurality of connector assemblies that can include a first connector and a second connector that are configured to connect to each other. The first connector can have a clamp flange and the second connector can have a clamp that engages with the clamp flange to lock the first connector and the second connector together to thereby connect and hold the mattress to the foundation.

Some embodiments described herein include a bed system. The bed system includes a foundation and a mattress configured to be positioned on top of the foundation. The system also includes a mattress attachment mechanism configured to connect the mattress to the foundation, the mattress attachment mechanism may include: a first connector connected to the mattress and including a clamp flange; a second connector connected to the foundation and including a clamp and a clamp actuator, the clamp actuator selectively moves the clamp between an unlocked position and a locked position; where the clamp receives the clamp flange when the clamp is in the unlocked position and, responsive to the clamp flange actuating a portion of the clamp actuator, the clamp actuator moves the clamp from the unlocked position to the locked position where the clamp engages with the clamp flange.

Such a system can include one or more of the following optional features. The bed system where the clamp may include a first clamp arm and a second clamp arm that actuate towards each other when the clamp moves from the unlocked position to the locked position. The clamp flange is positioned between the first clamp arm and the second clamp arm when the clamp engages with the clamp flange. The first connector includes a magnet guide and the second connector includes a magnet, the magnet guide and the magnet facilitate alignment between the clamp flange and the clamp. The clamp actuator includes an activation surface that is connected to an activation plate, where, responsive to an activation force at the activation surface, the activation surface actuates the activation plate to move the clamp from the unlocked position to the locked position. The clamp may include a first clamp arm and a second clamp arm, the first clamp arm includes a first arm base that includes a first actuation slot, the second clamp arm includes a second arm base that includes a second actuation slot. The activation plate includes a first actuation pin positioned in the first actuation slot, and a second actuation pin positioned in the second actuation slot. Responsive to actuation of the activation plate, the first actuation pin and the second actuation pin move within the first and second actuation slots to control the position of the first and second clamp arms. The first connector includes a first connector housing and the second connector includes a second connector housing, where, in the locked position, the first connector housing extends partially around the second connector housing. The first connector housing extends beyond a bottom surface of the mattress. The foundation may include an adjustable foundation configured for raising both a head and foot of the mattress when the adjustable foundation is actuated. The mattress attachment mechanism retains the mattress on the adjustable foundation during articulation of the adjustable foundation. The foundation may include a first articulable panel and a second articulable panel, the mattress attachment mechanism is positioned at a joint between the first and second panels. The first clamp arm includes a first arcuate flange, and the second clamp arm includes a second arcuate flange, the first and second arcuate flanges extend inwardly towards a center of the second connector.

Some embodiments described herein include a method of assembling a bed. The method also includes positioning a mattress on a foundation, the mattress having a first connector, and the foundation having a second connector at the foundation and configured to engage the first connector. The method also includes receiving a clamp flange of one of the first connector or second connector in a clamp of the other of the first connector or the second connector. The method also includes actuating the clamp from an unlocked position to a locked position around the clamp flange.

Such a method can include one or more of the following optional features. The method where the mattress may include a plurality of first connectors and the foundation may include a plurality of second connectors that are configured to engage with each other. The clamp is actuated responsive to the clamp flange engaging with an activation surface of the second connector. In the locked position, the clamp engages with the clamp flange to restrict movement of the mattress away from the foundation.

Some embodiments described herein include a bed system. The bed system includes a foundation and a mattress positioned on top of the foundation. The system also includes a mattress attachment mechanism may include: a clamp flange configured to connect the mattress to the foundation; and a clamp configured to releasably hold the clamp flange, the clamp may include first and second clamp arms that actuate between a locked position and an unlocked position, where in the locked position the first and second clamp arms are configured to engage with a portion of the clamp flange.

Some embodiments described herein include a bed system. The bed system includes a foundation having at least one articulable panel having a panel top surface. The system also includes a mattress configured to be positioned on the panel top surface. The system also includes a mattress attachment mechanism may include: a first connector positioned on a bottom surface of the mattress and configured to connect the mattress to the foundation; and a second connector configured to engage with the first connector, where at least a portion of the second connector is positioned on the panel top surface, and where at least at least one of the first connector or the second connector includes a clamp.

Such a system can include one or more of the following optional features. The bed system where at least one articulable panel may include a left head panel and a right head panel each having inner edges and outer edges, where the connector is positioned proximate to the inner edge of one of the left head panel or the right head panel.

Some embodiments described herein include a bed system. The bed system includes a foundation including a left head panel and a right head panel each having inner edges and outer edges. The system also includes at least one mattress configured to be positioned on top of the foundation. The system also includes left and right connector assemblies positioned proximate the inner edges of the left and right head panels, respectively, where the each of the left and right connector assemblies may include: a first connector at a bottom surface of the mattress and configured to connect the mattress to the foundation; and a second connector including a clamp configured to engage with the first connector, where at least a portion of the second connector is positioned on the panel top surface.

Such a system can include one or more of the following optional features. The bed system where the at least one mattress may include a split-top mattress that defines a split at a head edge of the split-top mattress. The at least one mattress may include first and second separate mattresses that are each sized to fit on about half of the foundation.

Some embodiments described herein include a bed system. The bed system includes a foundation and a mattress positioned on top of the foundation. The system also includes a mattress attachment mechanism may include: a first connector may include a means for connecting to the foundation; and a clamp configured to releasably engage with the first connector, the clamp is configured to move between a locked position and an unlocked position to retain the mattress to the foundation.

Some embodiments described herein include a clamp mechanism for use in a bed system. The clamp mechanism includes a first connector; a second connector, and a clamp configured to be actuated to releasably connect the first connector to the second connector.

The devices, systems, and techniques described herein may provide one or more of the following advantages. For example, the bed systems described herein facilitate an improved connection between a mattress and a foundation that can maintain consistent positioning of the mattress in relation to the foundation. This particularly benefits an articulable foundation. The bed systems described herein can also facilitate precise installation of a bed system that can have a mattress and a foundation because they are connectable to each other. The bed systems can provide intuitive and precise connector assemblies that facilitate connection of the mattress to the foundation. The bed systems described herein also advantageously improve contouring of the mattress between the articulable sections of the foundation. For example, the attachment mechanisms can reduce or minimize the gap between the mattress and the foundation. The reduced and/or minimized gap can provide improved contouring of the mattress to the foundation as the foundation is articulated into various positions.

The details of one or more implementations are set forth in the accompanying drawings and the description below. Other features, aspects and potential advantages will be apparent from the accompanying description and figures.

### DESCRIPTION OF DRAWINGS

FIG. 1 shows an example air bed system.

FIG. 2 is a block diagram of an example of various components of an air bed system.

FIG. 3 is a perspective view of an example bed system with an adjustable frame.

FIG. 4 is a top view of an example bed foundation with example first connector assemblies.

FIG. 5 is a bottom view of an example mattress with example second connector assemblies.

FIG. 6 is a top view of an example first connector assembly.

FIG. 7 is a bottom view of an example second connector assembly.

FIG. 8A is a perspective view of an example coupler assembly attached to a mattress and a foundation (shown as cut out portions in the illustration), according to an example.

FIG. 8B is another perspective view of the coupler assembly of FIG. 8A (with portions of the mattress and the foundation omitted from view).

FIG. 9A is a top view of the coupler assembly of FIG. 8B.

FIG. 9B is a bottom view of the coupler assembly of FIG. 8B.

FIG. 10 is a side view of the coupler assembly of FIG. 8A.

FIG. 11 is a partially exploded side view of the coupler assembly of FIG. 8A in a detached state.

FIG. 12A is a perspective view of the first connector assembly in an armed and disconnected position, consistent with some example embodiments.

FIG. 12B is a perspective view of the first connector assembly in a connected position (with the second connector assembly removed from view), consistent with some example embodiments.

FIG. 12C is a perspective view of the first connector assembly of FIG. 12A, with a housing removed from view.

FIG. 12D is a perspective view of the first connector assembly of FIG. 12B, with the housing removed from view.

FIG. 13 is an exploded side perspective view the coupler assembly of FIG. 8A

FIG. 14 is a cross-sectional side view along line 14-14 of the coupler assembly of FIG. 8A.

FIG. 15 is the cross-sectional side view of FIG. 14, with the first connector and second connector detached from each other.

Like reference symbols in the various drawings indicate like elements.

### DETAILED DESCRIPTION

This disclosure relates to bed systems (such as an airbed or other type of bed) that include a mattress and a foundation that can be connected to each other using, for example, connector assemblies. The bed system can include one or more connector assemblies that can connect the mattress and the foundation to each other. For example, a bed system can include a plurality of mattress connector assemblies that can include a first connector and a second connector that is configured to connect to the first connector. For example, the first connector can be connected to a bottom surface of a mattress and the second connector can be connected to the top surface of a foundation. The mattress and foundation can be connected by the plurality of connector assembles that are each in a connected position where the first connectors and second connectors engaged with each other.

In some embodiments, the first connector and the second connector can constitute a connector assembly. For example, the first connector and the second connector are connectable to each other. For example, the first connector can include a clamp flange that is connectable to a clamp of the second connector. The clamp can actuate from an unlocked position where the clamp does not engage with the clamp flange to a locked position where the clamp engages with the clamp flange to connect the first connector and the second connector together. This connection between the respective connector assemblies connects and holds the mattress to the foundation.

In some embodiments, the connection of the connector assemblies pulls the mattress and foundation together and reduces or minimizes a gap between the mattress and the foundation. The reduced and/or minimized gap can provide improved contouring of the mattress to the foundation as the foundation is articulated into various positions

### Example Airbed Hardware

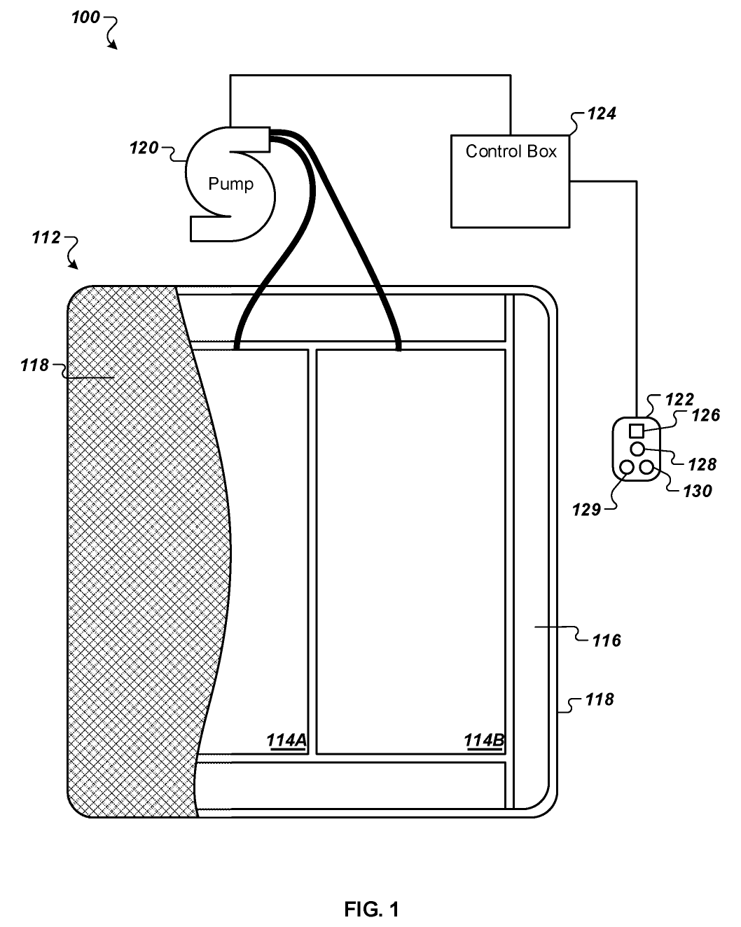

FIG. 1 shows an example air bed system 100 that includes a bed 112. The bed 112 can be a mattress that includes at least one air chamber 114 surrounded by a resilient border 116 and encapsulated by bed ticking 118. The resilient border 116 can comprise any suitable material, such as foam. In some implementations, the resilient border 116 can combine with a top layer or layers of foam (not shown in FIG. 1) to form an upside down foam tub. In other implementations, mattress structure can be varied as suitable for the application.

As illustrated in FIG. 1, the bed 112 can be a two chamber design having first and second fluid chambers, such as a first air chamber 114A and a second air chamber 114B. Sometimes, the bed 112 can include chambers for use with fluids other than air that are suitable for the application. For example, the fluids can include liquid. In some implementations, such as single beds or kids’ beds, the bed 112 can include a single air chamber 114A or 114B or multiple air chambers 114A and 114B. Although not depicted, sometimes, the bed 112 can include additional air chambers.

The first and second air chambers 114A and 114B can be in fluid communication with a pump 120. The pump 120 can be in electrical communication with a remote control 122 via control box 124. The control box 124 can include a wired or wireless communications interface for communicating with one or more devices, including the remote control 122. The control box 124 can be configured to operate the pump 120 to cause increases and decreases in the fluid pressure of the first and second air chambers 114A and 114B based upon commands input by a user using the remote control 122. In some implementations, the control box 124 is integrated into a housing of the pump 120. Moreover, sometimes, the pump 120 can be in wireless communication (e.g., via a home network, WIFI, BLUETOOTH, or other wireless network) with a mobile device via the control box 124. The mobile device can include but is not limited to the user’s smartphone, cell phone, laptop, tablet, computer, wearable device, home automation device, or other computing device. A mobile application can be presented at the mobile device and provide functionality for the user to control the bed 112 and view information about the bed 112. The user can input commands in the mobile application presented at the mobile device. The inputted commands can be transmitted to the control box 124, which can operate the pump 120 based upon the commands.

The remote control 122 can include a display 126, an output selecting mechanism 128, a pressure increase button 129, and a pressure decrease button 130. The remote control 122 can include one or more additional output selecting mechanisms and/or buttons. The display 126 can present information to the user about settings of the bed 112. For example, the display 126 can present pressure settings of both the first and second air chambers 114A and 114B or one of the first and second air chambers 114A and 114B. Sometimes, the display 126 can be a touch screen, and can receive input from the user indicating one or more commands to control pressure in the first and second air chambers 114A and 114B and/or other settings of the bed 112.

The output selecting mechanism 128 can allow the user to switch air flow generated by the pump 120 between the first and second air chambers 114A and 114B, thus enabling control of multiple air chambers with a single remote control 122 and a single pump 120. For example, the output selecting mechanism 128 can by a physical control (e.g., switch or button) or an input control presented on the display 126. Alternatively, separate remote control units can be provided for each air chamber 114A and 114B and can each include the ability to control multiple air chambers. Pressure increase and decrease buttons 129 and 130 can allow the user to increase or decrease the pressure, respectively, in the air chamber selected with the output selecting mechanism 128. Adjusting the pressure within the selected air chamber can cause a corresponding adjustment to the firmness of the respective air chamber. In some implementations, the remote control 122 can be omitted or modified as appropriate for an application.

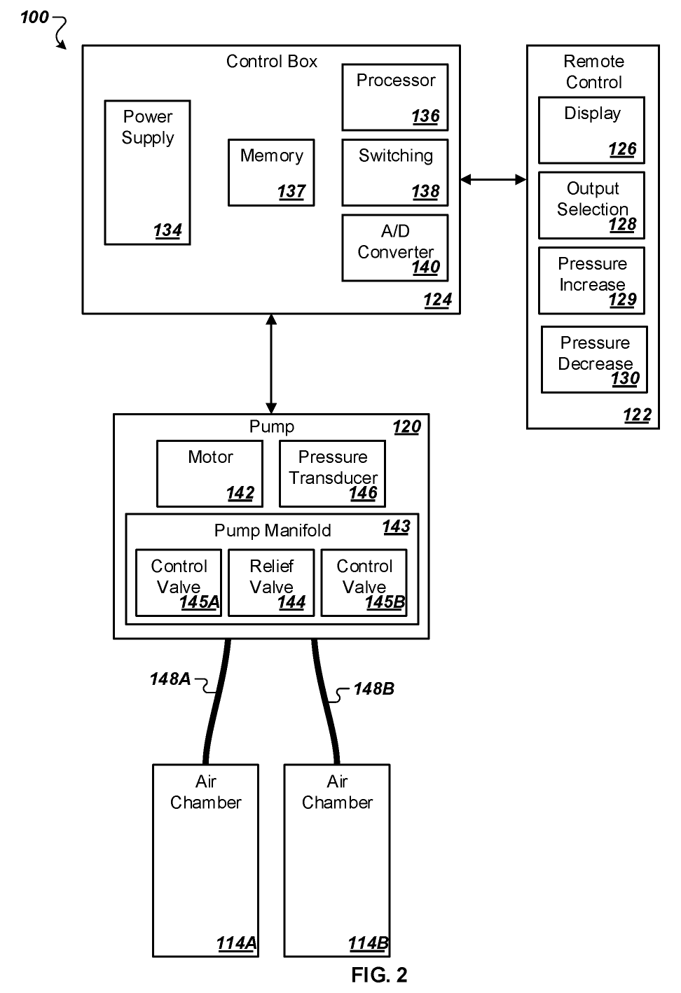

FIG. 2 is a block diagram of an example of various components of an air bed system. These components can be used in the example air bed system 100. The control box 124 can include a power supply 134, a processor 136, a memory 137, a switching mechanism 138, and an analog to digital (A/D) converter 140. The switching mechanism 138 can be, for example, a relay or a solid state switch. In some implementations, the switching mechanism 138 can be located in the pump 120 rather than the control box 124. The pump 120 and the remote control 122 can be in two-way communication with the control box 124. The pump 120 includes a motor 142, a pump manifold 143, a relief valve 144, a first control valve 145A, a second control valve 145B, and a pressure transducer 146. The pump 120 is fluidly connected with the first air chamber 114A and the second air chamber 114B via a first tube 148A and a second tube 148B, respectively. The first and second control valves 145A and 145B can be controlled by switching mechanism 138, and are operable to regulate the flow of fluid between the pump 120 and first and second air chambers 114A and 114B, respectively.

In some implementations, the pump 120 and the control box 124 can be provided and packaged as a single unit. In some implementations, the pump 120 and the control box 124 can be provided as physically separate units. The control box 124, the pump 120, or both can be integrated within or otherwise contained within a bed frame, foundation, or bed support structure that supports the bed 112. Sometimes, the control box 124, the pump 120, or both can be located outside of a bed frame, foundation, or bed support structure (as shown in the example in FIG. 1).

The air bed system 100 in FIG. 2 includes the two air chambers 114A and 114B and the single pump 120 of the bed 112 depicted in FIG. 1. However, other implementations can include an air bed system having two or more air chambers and one or more pumps incorporated into the air bed system to control the air chambers. For example, a separate pump can be associated with each air chamber. As another example, a pump can be associated with multiple chambers. A first pump can be associated with air chambers that extend longitudinally from a left side to a midpoint of the air bed system 100 and a second pump can be associated with air chambers that extend longitudinally from a right side to the midpoint of the air bed system 100. Separate pumps can allow each air chamber to be inflated or deflated independently and/or simultaneously. Additional pressure transducers can also be incorporated into the air bed system 100 such that a separate pressure transducer can be associated with each air chamber.

As an illustrative example, in use, the processor 136 can send a decrease pressure command to one of air chambers 114A or 114B, and the switching mechanism 138 can convert the low voltage command signals sent by the processor 136 to higher operating voltages sufficient to operate the relief valve 144 of the pump 120 and open the respective control valve 145A or 145B. Opening the relief valve 144 can allow air to escape from the air chamber 114A or 114B through the respective air tube 148A or 148B. During deflation, the pressure transducer 146 can send pressure readings to the processor 136 via the A/D converter 140. The A/D converter 140 can receive analog information from pressure transducer 146 and can convert the analog information to digital information useable by the processor 136. The processor 136 can send the digital signal to the remote control 122 to update the display 126 to convey the pressure information to the user. The processor 136 can also send the digital signal to other devices in wired or wireless communication with the air bed system, including but not limited to mobile devices described herein. The user can then view pressure information associated with the air bed system at their device instead of at, or in addition to, the remote control 122.

As another example, the processor 136 can send an increase pressure command. The pump motor 142 can be energized in response to the increase pressure command and send air to the designated one of the air chambers 114A or 114B through the air tube 148A or 148B via electronically operating the corresponding valve 145A or 145B. While air is being delivered to the designated air chamber 114A or 114B to increase the chamber firmness, the pressure transducer 146 can sense pressure within the pump manifold 143. The pressure transducer 146 can send pressure readings to the processor 136 via the A/D converter 140. The processor 136 can use the information received from the A/D converter 140 to determine the difference between the actual pressure in air chamber 114A or 114B and the desired pressure. The processor 136 can send the digital signal to the remote control 122 to update display 126.

Generally speaking, during an inflation or deflation process, the pressure sensed within the pump manifold 143 can provide an approximation of the actual pressure within the respective air chamber that is in fluid communication with the pump manifold 143. An example method includes turning off the pump 120, allowing the pressure within the air chamber 114A or 114B and the pump manifold 143 to equalize, then sensing the pressure within the pump manifold 143 with the pressure transducer 146. Providing a sufficient amount of time to allow the pressures within the pump manifold 143 and chamber 114A or 114B to equalize can result in pressure readings that are accurate approximations of actual pressure within air chamber 114A or 114B. In some implementations, the pressure of the air chambers 114A and/or 114B can be continuously monitored using multiple pressure sensors (not shown). The pressure sensors can be positioned within the air chambers. The pressure sensors can also be fluidly connected to the air chambers, such as along the air tubes 148A and 148B.

In some implementations, information collected by the pressure transducer 146 can be analyzed to determine various states of a user laying on the bed 112. For example, the processor 136 can use information collected by the pressure transducer 146 to determine a heartrate or a respiration rate for the user. As an illustrative example, the user can be laying on a side of the bed 112 that includes the chamber 114A. The pressure transducer 146 can monitor fluctuations in pressure of the chamber 114A, and this information can be used to determine the user’s heartrate and/or respiration rate. As another example, additional processing can be performed using the collected data to determine a sleep state of the user (e.g., awake, light sleep, deep sleep). For example, the processor 136 can determine when the user falls asleep and, while asleep, the various sleep states (e.g., sleep stages) of the user. Based on the determined heartrate, respiration rate, and/or sleep states of the user, the processor 136 can determine information about the user’s sleep quality. The processor 136 can, for example, determine how well the user slept during a particular sleep cycle. The processor 136 can also determine user sleep cycle trends. Accordingly, the processor 136 can generate recommendations to improve the user’s sleep quality and overall sleep cycle. Information that is determined about the user’s sleep cycle (e.g., heartrate, respiration rate, sleep states, sleep quality, recommendations to improve sleep quality, etc.) can be transmitted to the user’s mobile device and presented in a mobile application, as described above.

Additional information associated with the user of the air bed system 100 that can be determined using information collected by the pressure transducer 146 includes user motion, presence on a surface of the bed 112, weight, heart arrhythmia, snoring, partner snore, and apnea. One or more other health conditions of the user can also be determined based on the information collected by the pressure transducer 146. Taking user presence detection for example, the pressure transducer 146 can be used to detect the user’s presence on the bed 112, e.g., via a gross pressure change determination and/or via one or more of a respiration rate signal, heartrate signal, and/or other biometric signals. Detection of the user’s presence can be beneficial to determine, by the processor 136, adjustment(s) to make to settings of the bed 112 (e.g., adjusting a firmness when the user is present to a user-preferred firmness setting) and/or peripheral devices (e.g., turning off lights when the user is present, activating a heating or cooling system, etc.).

For example, a simple pressure detection process can identify an increase in pressure as an indication that the user is present. As another example, the processor 136 can determine that the user is present if the detected pressure increases above a specified threshold (so as to indicate that a person or other object above a certain weight is positioned on the bed 112). As yet another example, the processor 136 can identify an increase in pressure in combination with detected slight, rhythmic fluctuations in pressure as corresponding to the user being present. The presence of rhythmic fluctuations can be identified as being caused by respiration or heart rhythm (or both) of the user. The detection of respiration or a heartbeat can distinguish between the user being present on the bed and another object (e.g., a suitcase, a pet, a pillow, etc.) being placed thereon.

In some implementations, pressure fluctuations can be measured at the pump 120. For example, one or more pressure sensors can be located within one or more internal cavities of the pump 120 to detect pressure fluctuations within the pump 120. The fluctuations detected at the pump 120 can indicate pressure fluctuations in the chambers 114A and/or 114B. One or more sensors located at the pump 120 can be in fluid communication with the chambers 114A and/or 114B, and the sensors can be operative to determine pressure within the chambers 114A and/or 114B. The control box 124 can be configured to determine at least one vital sign (e.g., heartrate, respiratory rate) based on the pressure within the chamber 114A or the chamber 114B.

The control box 124 can also analyze a pressure signal detected by one or more pressure sensors to determine a heartrate, respiration rate, and/or other vital signs of the user lying or sitting on the chamber 114A and/or 114B. More specifically, when a user lies on the bed 112 and is positioned over the chamber 114A, each of the user’s heart beats, breaths, and other movements (e.g., hand, arm, leg, foot, or other gross body movements) can create a force on the bed 112 that is transmitted to the chamber 114A. As a result of this force input, a wave can propagate through the chamber 114A and into the pump 120. A pressure sensor located at the pump 120 can detect the wave, and thus the pressure signal outputted by the sensor can indicate a heartrate, respiratory rate, or other information regarding the user.

With regard to sleep state, the air bed system 100 can determine the user’s sleep state by using various biometric signals such as heartrate, respiration, and/or movement of the user. While the user is sleeping, the processor 136 can receive one or more of the user’s biometric signals (e.g., heartrate, respiration, motion, etc.) and can determine the user’s present sleep state based on the received biometric signals. In some implementations, signals indicating fluctuations in pressure in one or both of the chambers 114A and 114B can be amplified and/or filtered to allow for more precise detection of heartrate and respiratory rate.

Sometimes, the processor 136 can receive additional biometric signals of the user from one or more other sensors or sensor arrays positioned on or otherwise integrated into the air bed system 100. For example, one or more sensors can be attached or removably attached to a top surface of the air bed system 100 and configured to detect signals such as heartrate, respiration rate, and/or motion. The processor 136 can combine biometric signals received from pressure sensors located at the pump 120, the pressure transducer 146, and/or the sensors positioned throughout the air bed system 100 to generate accurate and more precise information about the user and their sleep quality.

Sometimes, the control box 124 can perform a pattern recognition algorithm or other calculation based on the amplified and filtered pressure signal(s) to determine the user’s heartrate and/or respiratory rate. For example, the algorithm or calculation can be based on assumptions that a heartrate portion of the signal has a frequency in a range of 0.5-4.0 Hz and that a respiration rate portion of the signal has a frequency in a range of less than 1 Hz. Sometimes, the control box 124 can use one or more machine learning models to determine the user’s health information. The models can be trained using training data that includes training pressure signals and expected heartrates and/or respiratory rates. Sometimes, the control box 124 can determine user health information by using a lookup table that corresponds to sensed pressure signals.

The control box 124 can also be configured to determine other characteristics of the user based on the received pressure signal, such as blood pressure, tossing and turning movements, rolling movements, limb movements, weight, presence or lack of presence of the user, and/or the identity of the user.

For example, the pressure transducer 146 can be used to monitor the air pressure in the chambers 114A and 114B of the bed 112. If the user on the bed 112 is not moving, the air pressure changes in the air chamber 114A or 114B can be relatively minimal, and can be attributable to respiration and/or heartbeat. When the user on the bed 112 is moving, however, the air pressure in the mattress can fluctuate by a much larger amount. The pressure signals generated by the pressure transducer 146 and received by the processor 136 can be filtered and indicated as corresponding to motion, heartbeat, or respiration. The processor 136 can attribute such fluctuations in air pressure to the user’s sleep quality. Such attributions can be determined based on applying one or more machine learning models and/or algorithms to the pressure signals. For example, if the user shifts and turns a lot during a sleep cycle (for example, in comparison to historic trends of the user’s sleep cycles), the processor 136 can determine that the user experienced poor sleep during that particular sleep cycle.

In some implementations, rather than performing the data analysis in the control box 124 with the processor 136, a digital signal processor (DSP) can be provided to analyze the data collected by the pressure transducer 146. Alternatively, the collected data can be sent to a cloud-based computing system for remote analysis.

In some implementations, the example air bed system 100 further includes a temperature controller configured to increase, decrease, or maintain a temperature of the bed 112, for example for the comfort of the user. For example, a pad (e.g., mat, layer, etc.) can be placed on top of or be part of the bed 112, or can be placed on top of or be part of one or both of the chambers 114A and 114B. Air can be pushed through the pad and vented to cool off the user on the bed 112. Additionally or alternatively, the pad can include a heating element used to keep the user warm. In some implementations, the temperature controller can receive temperature readings from the pad. The temperature controller can determine whether the temperature readings are less than or greater than some threshold range and/or value. Based on this determination, the temperature controller can actuate components to push air through the pad to cool off the user or active the heating element. In some implementations, separate pads are used for different sides of the bed 112 (e.g., corresponding to the locations of the chambers 114A and 114B) to provide for differing temperature control for the different sides of the bed 112. Each pad can be selectively controlled by the temperature controller to provide cooling or heating preferred by each user on the different sides of the bed 112. For example, a first user on a left side of the bed 112 can prefer to have their side of the bed 112 cooled during the night while a second user on a right side of the bed 112 can prefer to have their side of the bed 112 warmed during the night.

In some implementations, the user of the air bed system 100 can use an input device, such as the remote control 122 or a mobile device as described above, to input a desired temperature for a surface of the bed 112 (or for a portion of the surface of the bed 112, for example at a foot region, a lumbar or waist region, a shoulder region, and/or a head region of the bed 112). The desired temperature can be encapsulated in a command data structure that includes the desired temperature and also identifies the temperature controller as the desired component to be controlled. The command data structure can then be transmitted via Bluetooth or another suitable communication protocol (e.g., WIFI, a local network, etc.) to the processor 136. In various examples, the command data structure is encrypted before being transmitted. The temperature controller can then configure its elements to increase or decrease the temperature of the pad depending on the temperature input provided at the remote control 122 by the user.

In some implementations, data can be transmitted from a component back to the processor 136 or to one or more display devices, such as the display 126 of the remote controller 122. For example, the current temperature as determined by a sensor element of a temperature controller, the pressure of the bed, the current position of the foundation or other information can be transmitted to control box 124. The control box 124 can transmit this information to the remote control 122 to be displayed to the user (e.g., on the display 126). As described above, the control box 124 can also transmit the received information to a mobile device to be displayed in a mobile application or other graphical user interface (GUI) to the user.

In some implementations, the example air bed system 100 further includes an adjustable foundation and an articulation controller configured to adjust the position of the bed 112 by adjusting the adjustable foundation supporting the bed. For example, the articulation controller can adjust the bed 112 from a flat position to a position in which a head portion of a mattress of the bed is inclined upward (e.g., to facilitate a user sitting up in bed and/or watching television). The bed 112 can also include multiple separately articulable sections. As an illustrative example, the bed 112 can include one or more of a head portion, a lumbar/waist portion, a leg portion, and/or a foot portion, all of which can be separately articulable. As another example, portions of the bed 112 corresponding to the locations of the chambers 114A and 114B can be articulated independently from each other, to allow one user positioned on the bed 112 surface to rest in a first position (e.g., a flat position or other desired position) while a second user rests in a second position (e.g., a reclining position with the head raised at an angle from the waist or another desired position). Separate positions can also be set for two different beds (e.g., two twin beds placed next to each other). The foundation of the bed 112 can include more than one zone that can be independently adjusted.

Sometimes, the bed 112 can be adjusted to one or more user-defined positions based on user input and/or user preferences. For example, the bed 112 can automatically adjust, by the articulation controller, to one or more user-defined settings. As another example, the user can control the articulation controller to adjust the bed 112 to one or more user-defined positions. Sometimes, the bed 112 can be adjusted to one or more positions that may provide the user with improved or otherwise improve sleep and sleep quality. For example, a head portion on one side of the bed 112 can be automatically articulated, by the articulation controller, when one or more sensors of the air bed system 100 detect that a user sleeping on that side of the bed 112 is snoring. As a result, the user’s snoring can be mitigated so that the snoring does not wake up another user sleeping in the bed 112.

In some implementations, the bed 112 can be adjusted using one or more devices in communication with the articulation controller or instead of the articulation controller. For example, the user can change positions of one or more portions of the bed 112 using the remote control 122 described above. The user can also adjust the bed 112 using a mobile application or other graphical user interface presented at a mobile computing device of the user.

The articulation controller can also provide different levels of massage to one or more portions of the bed 112 for one or more users. The user(s) can adjust one or more massage settings for the portions of the bed 112 using the remote control 122 and/or a mobile device in communication with the air bed system 100.

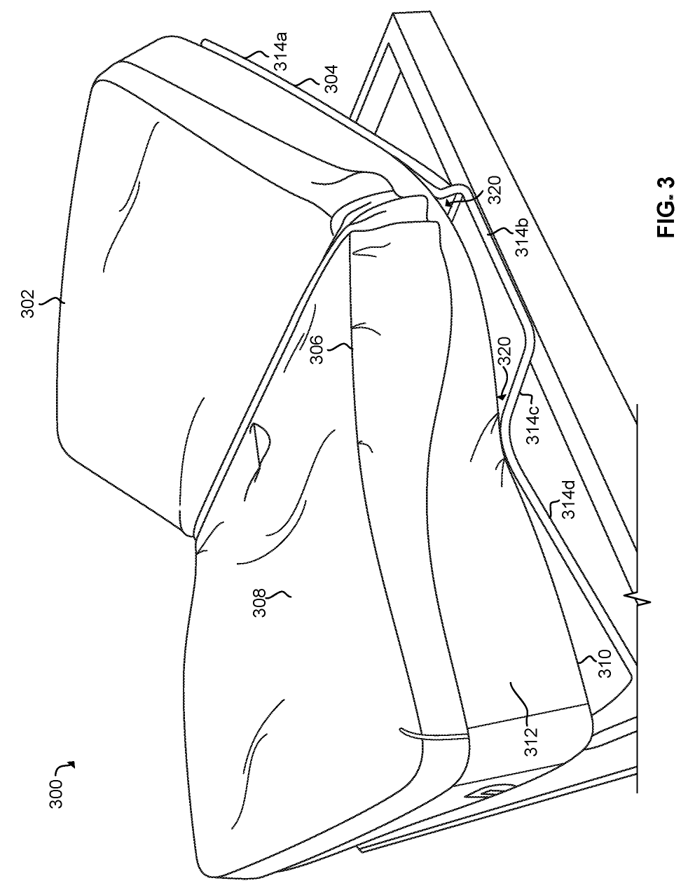

FIG. 3 shows another example bed system 300 that includes a mattress 302 and an articulable foundation 304. The mattress 302 can be positioned on top of the foundation 304 to provide a comfortable, supportive sleep area for the user. The mattress 302 can include a support structure (see e.g., the air chambers 114A, 114B surrounded by the resilient border 116 as shown in FIG. 1) encapsulated by an outer fabric layer 306. As may be appreciated, any known support structure or combination of support structures may be used. The mattress 302 can include a top 308, a bottom 310, and sides 312 extending between the top 308 and the bottom 310. The foundation 304 can include one or more sections 314a, 314b, 314c, and 314d. The foundation may have less than or greater than four sections in different embodiments. One or more of the sections 314a, 314b, 314c, and 314d can be articulable sections for positioning various sections of the mattress 302 into various spatial configurations, as desired by the user. The foundation 304 can move into the various spatial configurations by changing the heights and adjusting the angles of one or more of its articulable sections 314a, 314b, 314c, and 314d relative to one another.

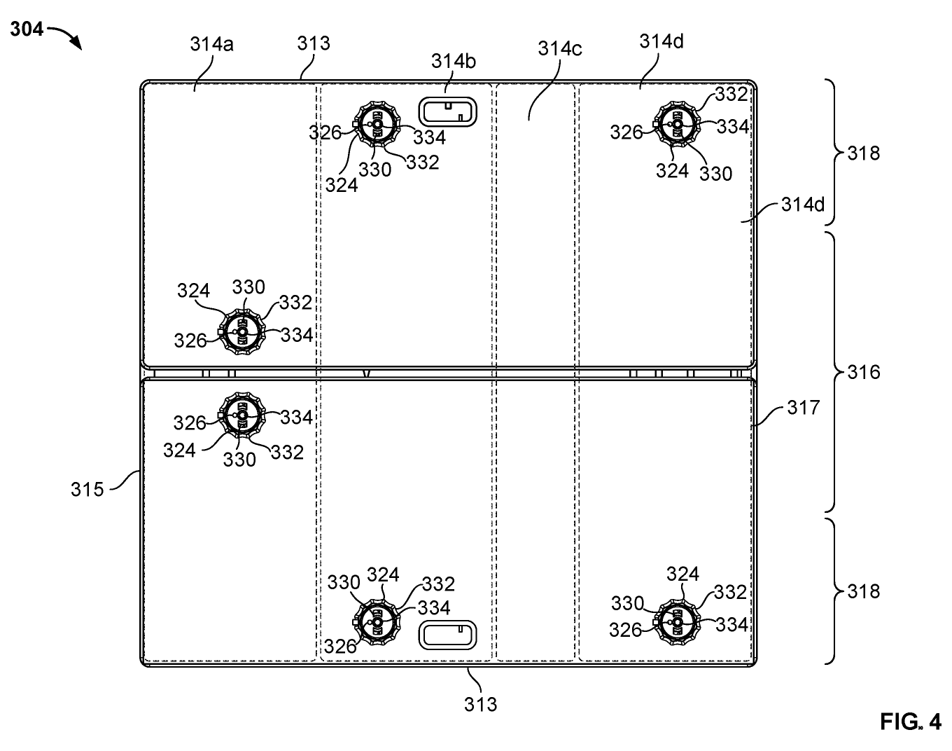

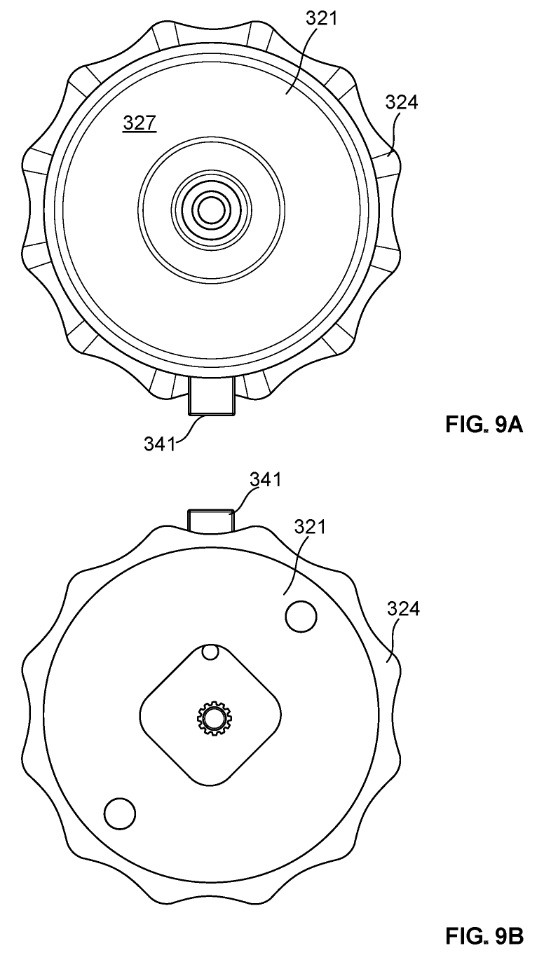

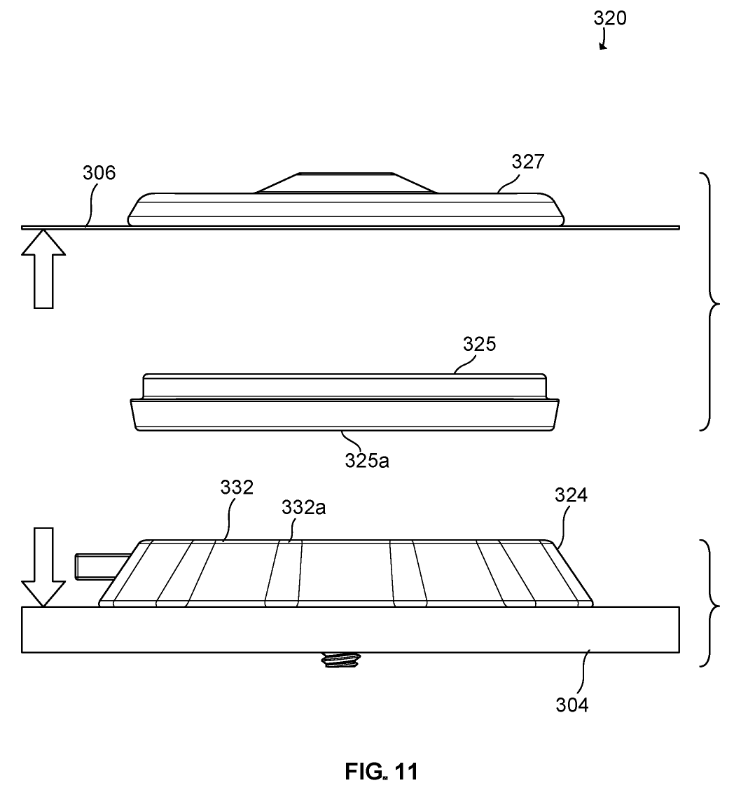

The bottom 310 of the mattress 302 can be coupled to the foundation 304 by one or more connector assemblies 320 (further illustrated in FIG. 4-15) such that the mattress 302 is retained along a top surface of the foundation 304 to reduce or prevent sliding when the articulable sections 314a, 314b, 314c, and 314d change their positions. In some embodiments, the connector assemblies 320 include a first connector 321 and a second connector 324 (see e.g., FIGS. 4-8B) that are configured to connect to each other to connect the mattress 302 to the foundation 304. This allows the mattress 302 to remain aligned with the foundation 304 when articulated such that the mattress 302 does not slide out of alignment with the foundation 304. The one or more connector assemblies 320 hold the mattress 302 in position to prevent the mattress 302 from sliding off the foundation 304. The one or more connector assemblies 320 reduces or minimizes a gap between the mattress 302 and the foundation 304. The one or more connector assemblies 320 maintain the mattress 302 in a consistent and predictable position that prevents the mattress 302 from bunching against an adjacent structure such as a wall or a head or foot frame. The connector assemblies 320 can thus provide a secure and reliable method of attaching or detaching the mattress 302 to the foundation 304.

FIG. 4 shows a top view of the foundation 304 that includes locations for attaching one or more second connectors 324. The depicted foundation 304 includes four sections: a head section 314a, an upper midsection 314b, a lower midsection 314c, and a foot section 314d. The foundation 304 can be sized and shaped for any mattress size, for example, a king, a split-top king, a queen, a full, a twin, a twin XL sized mattress, or a custom-sized mattress. The second connectors 324 can be positioned at one or more locations along a top surface of the foundation 304 such that the second connectors 424 interface with one or more first connectors (e.g., first connectors 321) to secure a mattress (e.g., a mattress 302) to the foundation 304.

In some cases, the foundation 304 can accommodate any number of second connectors 324 (e.g., two, three, four, five, six, eight, ten, twelve, fourteen, sixteen, eighteen, or greater than twenty). In some cases, the second connector 324 can be positioned at locations symmetrically along the foundation 304 (e.g., with respect to a longitudinal axis of the foundation 304) to facilitate securement and alignment of the mattress. In some instances, the positions of the second connectors 324 reduce or minimize the amount of shear force exerted on the mattress, preventing misalignment, separation, or detachment of the mattress from the foundation 304. Alternatively, in some cases, the second connectors 324 can be asymmetrically positioned along the surface of the foundation 304 to allow for easier movement and conformance of the mattress when the foundation 304 is articulated. For example, second connectors 324 can be positioned in areas such as at the peripheral portions 318 of the upper midsection 314b to provide improved conformance of the mattress to the foundation 304 when the foundation 304 is articulated. Second connector 324 can additionally be positioned along the central portion 316 and/or the peripheral portions 318 in any of the head section 314a, the upper midsection 314b, the lower midsection 314c, and the foot section 314d. In an asymmetric arrangement, the second connectors 324 can be positioned at various locations along the central portion 316 to facilitate conformance of the mattress to the foundation 304 when the foundation 304 is articulated. The depicted foundation 304 can be compatible and couplable with a mattress (see e.g., mattress 302) having a complementary set of first connectors (e.g., first connectors 321) attached along the bottom surface of the mattress.

As shown in FIG. 4, the head section 314a of the foundation 304 includes one set of two symmetrically positioned second connectors 324, the upper midsection 314b includes one set of two symmetrically positioned second connectors 324, and the foot section 314d includes a set of two symmetrically positioned second connectors 324. In some cases, some of the articulable sections of the foundation 304 may not include second connectors 324 (e.g., the head section 314a and the lower midsection 314c). In some cases, any one section of the foundation 304 can include one or more sets of second connectors 324. In some cases, any one section of the foundation 304 can include a single second connector 324 or a set of second connectors 324, either symmetrically or asymmetrically positioned.

The foundation 304 can include a central portion 316 that is positioned between peripheral portions 318. The peripheral portions 318 can extend from the central portion 316 to the sides 313 of the foundation 304. In the implementation depicted in FIG. 4, the second connector 324 at the upper midsection 314b are located at peripheral portions 318 of the foundation 304. The second connector 324 at the foot section 314d are positioned at peripheral portions 318 of the foundation 304.

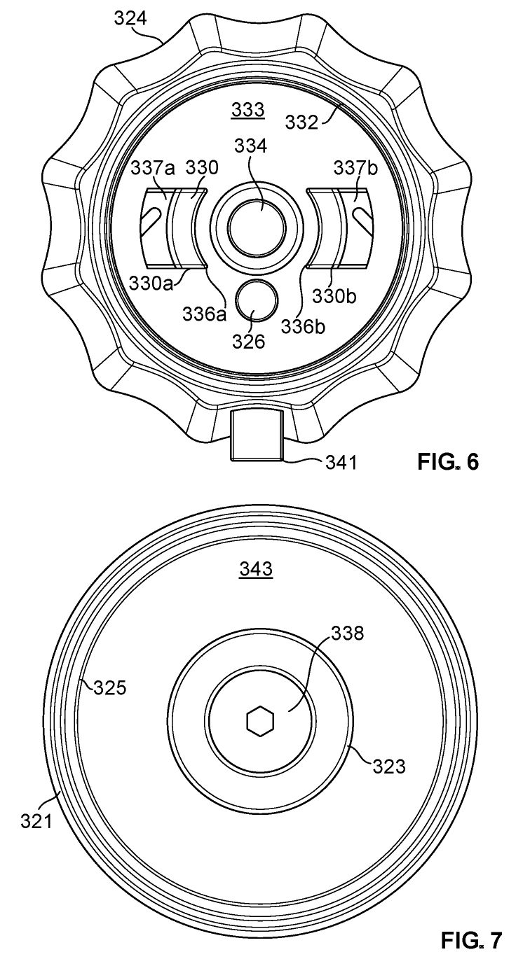

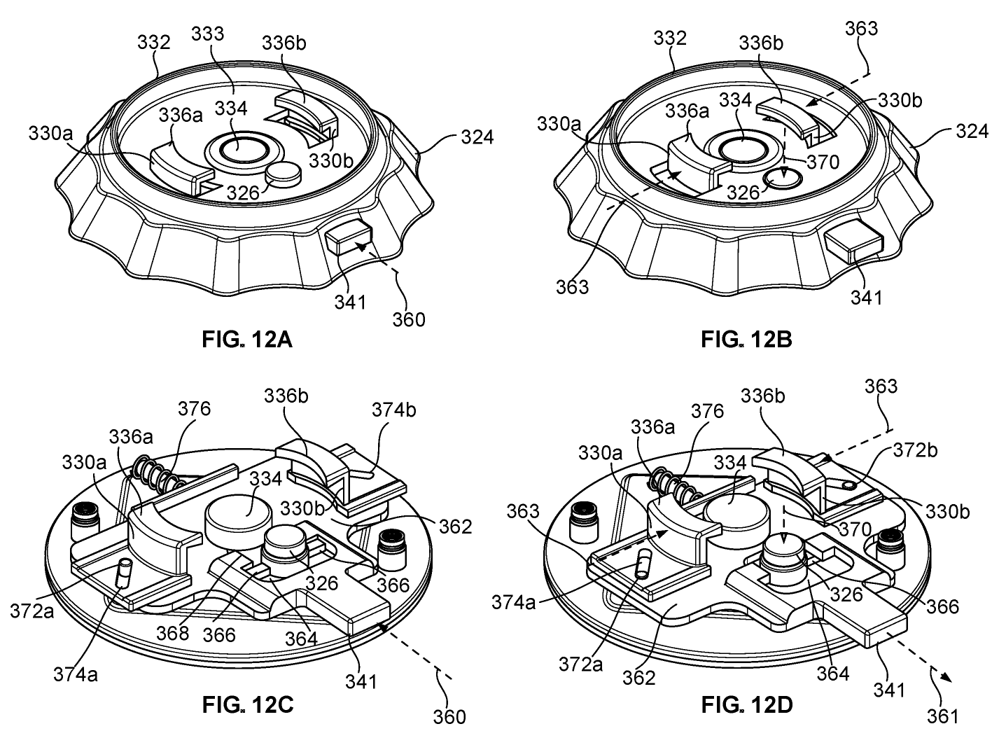

Still referring to FIG. 4, each of the second connectors 324 includes a clamp 330, a second connector housing 332, an activation surface 326, and a magnet 334. The second connectors 324 can be arranged on the foundation 304 so that the clamp 330 extends from a top surface of the foundation 304 such that the second connectors 324 can be easily accessed during assembly and/or disassembly of the bed system. An example of the second connector 324 is further described in FIG. 6 and FIGS. 12A-D.

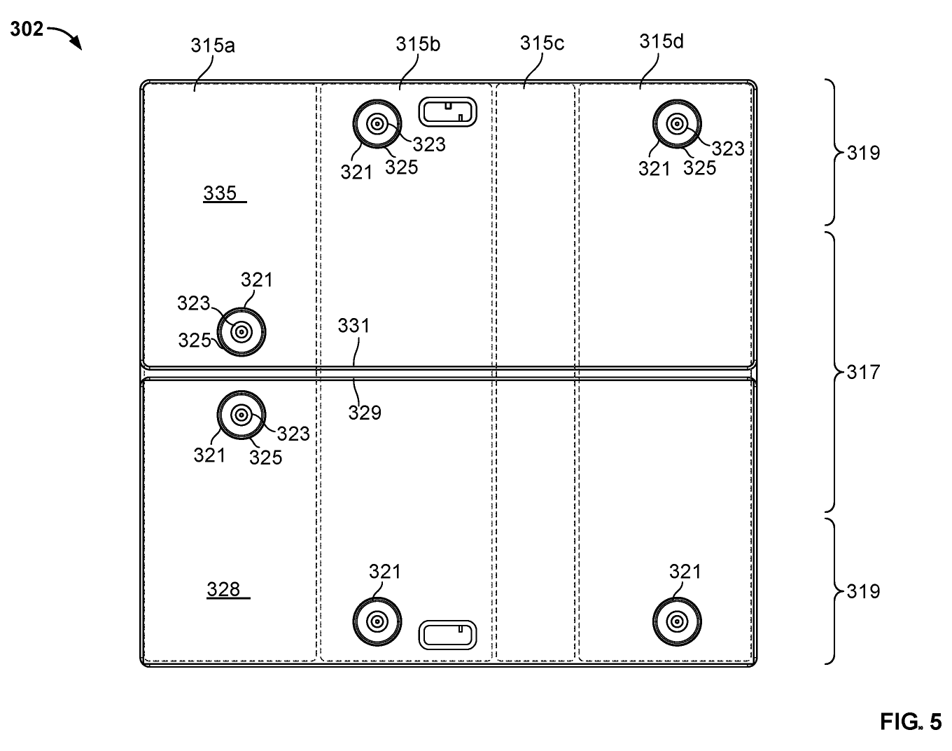

FIG. 5 shows a bottom view of the mattress 302 including various first connectors 321. The depicted mattress 302 can be sized and shaped as any mattress size, for example, a king, a split-top king, a queen, a full, a twin, a twin XL sized mattress, or a custom-sized mattress. The first connectors 321 can be arranged to correspond to the positions of the second connectors 324 of the foundation to which the mattress is supported and coupled. The first connectors 321 can be positioned at one or more locations along a bottom surface of the mattress 302 such that first connectors 321 interface with one or more connector assemblies (e.g., second connectors 324) to secure the mattress 302 to a foundation (e.g., foundation 304). In some implementations, the foundation 304 and the mattress 302 are configured to be connected to each other by connecting the first connectors 321 to the second connectors 324. The depicted mattress 302 can include four sections: a head section 315a, an upper midsection 315b, a lower midsection 315c, and a foot section 315d that can be configured to align with the head section 314a, an upper midsection 314b, a lower midsection 314c, and a foot section 314d of the foundation 304. In some embodiments, the sections (e.g., head section 315a, upper midsection 315b, lower midsection 315c, and foot section 315d) of the mattress 302 are not physically separate sections. For example, the sections (e.g., head section 315a, upper midsection 315b, lower midsection 315c, and foot section 315d) of the mattress 302 are areas of a bottom surface of the mattress 302 that, when connected to the foundation 304, are configured to align with the head section 314a, an upper midsection 314b, a lower midsection 314c, and a foot section 314d of the foundation 304.

In the depicted implementation of FIG. 5, the first connectors 321 are shown in an uninstalled configuration where the first connectors 321 are not connected to the second connectors 324. Each of the first connectors 321 can include a clamp flange 323 and a first connector housing 325. Each clamp flange 323 is configured to engage with a corresponding clamp 330 of the second connector 324 to connect the first connector 321 to the second connector 324. In some embodiments, the clamp flange 323 includes a clamp flange rim 388 that extends circumferentially around the clamp flange 323. In some embodiments, the first connector 321 includes a means to connect to the second connector 324. For example, the first connector 321 can include the clamp flange 323, a snap, a buckle, a strap, a hook-and-loop fastener, a magnet, a clip, or another means for connecting the mattress to the foundation.

Referring to FIG. 5, in some cases, the mattress 302 can accommodate any number of first connectors 321 (e.g., two, three, four, five, six, eight, ten, twelve, fourteen, sixteen, eighteen, twenty, or greater than twenty). In some cases, the first connectors 321 can be positioned at locations symmetrically along the mattress 302 to facilitate securement and alignment of the mattress to the foundation. In some instances, the positions of the first connectors 321 can be aligned with the second connectors 324 to reduce or minimize the amount of shear force exerted on the mattress 302, preventing misalignment, separation, or detachment of the mattress from the foundation. Alternatively, in some cases, the first connectors 321 can be asymmetrically positioned along the bottom 310 of the mattress 302 to allow for easier movement and conformance of the mattress 302 when the foundation is articulated. The depicted mattress 302 can be compatible and couplable with a foundation mattress (see e.g., foundation 304) having a complementary set of connector assemblies (e.g., second connectors 324) attached along the top surface of the foundation.

As shown in FIG. 5, the head section 315a of the mattress 302 includes a set of two symmetrically positioned first connectors 321, the upper midsection 315b of the mattress 302 includes one set of two symmetrically positioned first connectors 321, and the foot section 315d includes a set of two symmetrically positioned first connectors 321. In some cases, some of the sections of the mattress 302 may not include first connectors 321 (e.g., the head section 315a and the lower midsection 315c). In some cases, any one section of the mattress 302 can include one or more sets of first connectors 321. In some cases, any one section of the mattress 302 can include one first connector 321 or a set (e.g., two first connectors 321), either symmetrically or asymmetrically positioned.

As depicted in FIG. 5, the first connectors 321 at the head section 315a are positioned along the inner edges 329 and 331 of the left head panel 328 and right head panel 335, respectively. In some cases, the pair of first connectors 321 at the head section 315a are positioned closer to one another than the pair of first connectors 321 at the upper midsection 315b. Such a configuration may be desirable in an articulable bed system having separately articulable head sections, such as an articulable bed system that is split with two separately articulable mattresses or an articulable bed system with a split head section and a joined foot section. In some cases, the first connectors 321 and the second connectors 324 may be positioned on the mattress 302 and the foundation 304 such that the connector assemblies 320 can be easily accessed during assembly and/or disassembly of the bed system.

The mattress 302 can include a central portion 317 that is positioned between peripheral portions 319. The central portion 317 can align with the central portion 316 of the foundation 304, and the peripheral portions 319 can align with the peripheral portions 318 of the foundation 304. In the implementation depicted in FIG. 5, the first connectors 321 at the upper midsection 315b are located at peripheral portions 319 of the mattress 302. The first connectors 321 at the foot section 315d are positioned at peripheral portions 319 of the mattress 302. The first connectors 321 can be positioned to align with and connect to the second connectors 324 of the foundation 304 to connect the mattress 302 to the foundation 304. In some embodiments, the second connectors 324 can be positioned on the mattress 302 and the first connectors 321 can be positioned on the foundation. For example, the first connectors 321 can be positioned along a top surface of the foundation 304 and the second connectors 324 can be positioned along bottom surface of the mattress 302.

Referring to FIG. 6, the second connector 324 can include the clamp 330, the second connector housing 332, the activation surface 326, and the magnet 334. The second connector housing 332 extends around the clamp 330, the activation surface 326, and the magnet 334. The clamp 330 includes a first clamp arm 330a and a second clamp arm 330b that actuate towards each other when the clamp 330 moves from the unlocked position (see e.g., FIG. 12C) to the locked position (see e.g., FIGS. 6 and 12D). In some embodiments, the clamp 330 includes the first clamp arm 330a and the second clamp arm 330b. Each of the first clamp arm 330a and the second clamp arm 330b can extend through a second connector plate 333. The second connector plate 333 includes clamp openings 337a and 337b that the first clamp arm 330a and the second clamp arm 330b can extend through.

In some embodiments, each of the first clamp arm 330a and the second clamp arm 330b can include arcuate flanges 336a, 336b that extend from each clamp arm 330a, 330b on opposing sides of the magnet 334. For example, the first clamp arm 330a has a concave surface facing towards a concave surface of the second clamp arm 330b. In some embodiments, the first and second arcuate flanges 336a, 336b extend inwardly towards a center of the second connector 324 (e.g., towards the magnet 334).

The second connector 324 can also include the activation surface 326. The activation surface 326 can interface with the clamp flange 323 to control the position of the clamp 330 (e.g., actuation of the clamp 330 between the locked and unlocked positions). In some embodiments, the activation surface 326 is a spring-loaded button that extends from the second connector plate 333 and can engage with the clamp flange 323 when the first connector 321 engages with the second connector 324. The activation surface 326 can be a spring-loaded button, a button, a tab, a magnet, a lever, a switch, a strap, a buckle, a snap connector, combinations thereof, or another activation surface that interfaces with the first connector 321. The activation surface 326 is described further with respect to FIGS. 12A-12C.

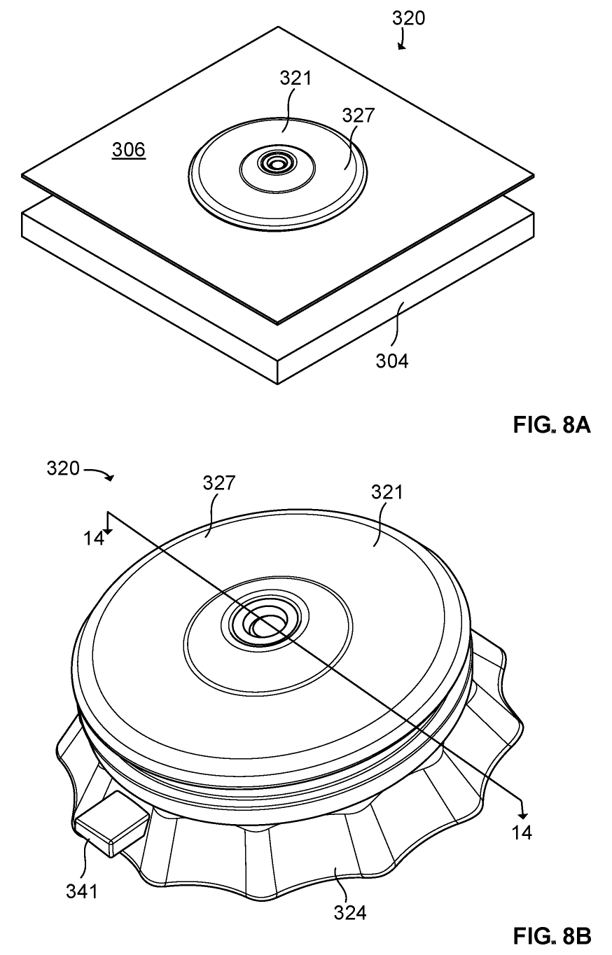

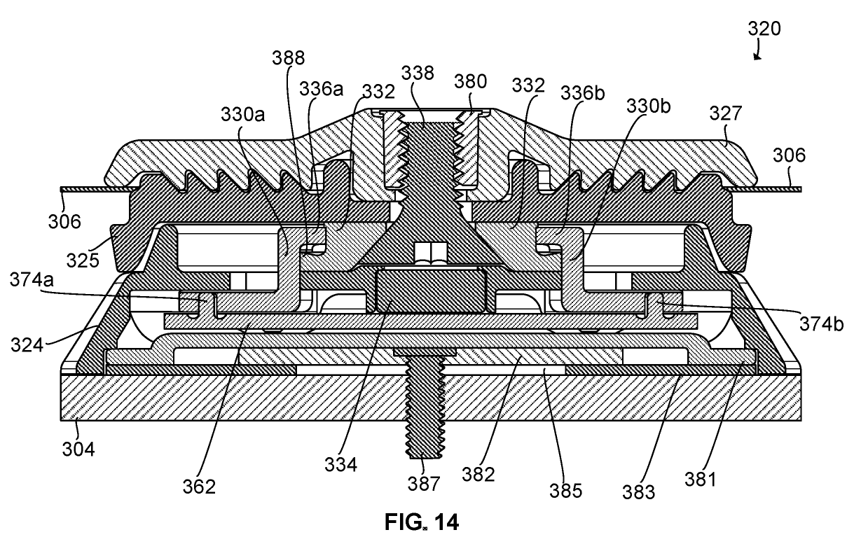

Referring to FIG. 7, the first connector 321 can include the clamp flange 323, the first connector housing 325, and a magnet guide 338. The clamp flange 323 protrudes outwardly from the first connector 321. For example, the clamp flange 323 can extend from a first connector plate 343 such that the clamp flange 323 is configured to engage with the clamp 330 of the second connector 324 when the first connector 321 and the second connector 324 are engaged with each other (see e.g., FIGS. 8A-10 and 14). The clamp flange 323 can be configured to engage with the arcuate flanges 336a, 336b of the clamp 330. For example, the clamp flange 323 can include a rounded shape that engages with each of the arcuate flanges 336a, 336b when the first connector 321 is engaged with the second connector 324. The clamp flange 323 can be dimensioned to fit between the first clamp arm 330a and the second clamp arm 330b when the clamp 330 is in an open or unlocked position. The clamp flange 323 can be dimensioned to engage with the arcuate flanges 336a, 336b when the clamp 330 closes around the clamp flange 323 (see e.g., FIGS. 12B, 12D, and FIG. 14).

In some embodiments, the clamp 330 can engage with the clamp flange 323 while not engaging with the entire outer surface of the clamp flange 323. For example, the clamp flange 323 can include a clamp flange rim 388 that extends around a circumference of the clamp flange 323. The arcuate flanges 336a, 336b can extend over the clamp flange rim 388 to retain the clamp flange 323 within the clamp 330. The arcuate flanges 336a, 336b can extend around a portion of the clamp flange 323, while a remainder of the clamp flange 323 is not engaged by the clamp 330. For example, between 30 and 40 percent, between 40 and 50 percent, between 50 and 60 percent, between 60 and 70 percent, or over 70 percent of the clamp flange 323 is not engaged by or in contact with the clamp 330 in the locked position. In any of these ranges, the clamp 330 can restrain the clamp flange 323 from actuating away from the second connector 324 in the locked position.

In some embodiments, the clamp flange 323 can include a rounded shape. The rounded shape can be complimentary to the shape of the arcuate flanges 336a, 336b and facilitate engagement between the arcuate flanges 336a, 336b and the clamp flange 323. The clamp flange 323 can include various shapes including rounded shapes, oblong shapes, ovular shapes, rectangular shapes, square shapes, pentagons, hexagons, octagons, decagons, or other shapes.

The clamp flange 323 can surround the magnet guide 338 of the first connector 321. In some embodiments, the magnet guide 338 can be at a center of the first connector 321 and aligned with a center of the clamp flange 323. The magnet guide 338 can facilitate alignment with the magnet 334 of the second connector 324. For example, the magnetic attraction between the magnet 334 and the magnet guide 338 can facilitate alignment of the first connector 321 and the second connector 324. In particular, the magnet 334 and magnet guide 338 can facilitate connection of the first connector 321 and the second connector 324 when the clamp 330 and the clamp flange 323 are not visible to a user. As the first connector 321 and the second connector 324 are aligned, the magnet 334 and magnet guide 338 can facilitate a centering of the clamp flange 323 between the first clamp arm 330a and second clamp arm 330b. In some embodiments, the magnet guide 338 can be a metallic material. For example, the magnet guide 338 can be a metallic fastener that connects the clamp flange 323 to the first connector 321 and also facilitates alignment with the magnet 334. In some cases, the magnet 334 can be a relatively weak magnet that is strong enough to assist with alignment but not strong enough to hold the first connector 321 to the second connector 324 on its own power.

Referring to FIGS. 8A-11, the connector assembly 320 is illustrated in a connected configuration and removed from the bed system (e.g., bed system 300). The connector assembly 320 includes the first connector 321 and the second connector 324, which are configured to engage with each other to connect the mattress and the foundation together. For example, the first connector 321 is connected to the mattress (e.g., mattress 302) and the second connector 324 is connected to the foundation (e.g., foundation 304). In some embodiments, the first connector 321 is connected to the mattress and has the fabric layer 306 sandwiched between the first connector housing 325 and an outer first connector housing 327. A cross sectional side view along the line 14-14 of FIG. 8B of the connector assembly 320 is also discussed below in reference to FIG. 14.

The first connector housing 325 can extend beyond the fabric layer 306 and be exposed to the second connector 324 to facilitate a connection between the first connector 321 and the second connector 324. The second connector 324 including the second connector housing 332 can be connected to a top surface of the foundation 304 and extend beyond the foundation 304. The second connector 324 can be exposed from the foundation 304 to the first connector 321 to facilitate a connection of the connector assembly 320.

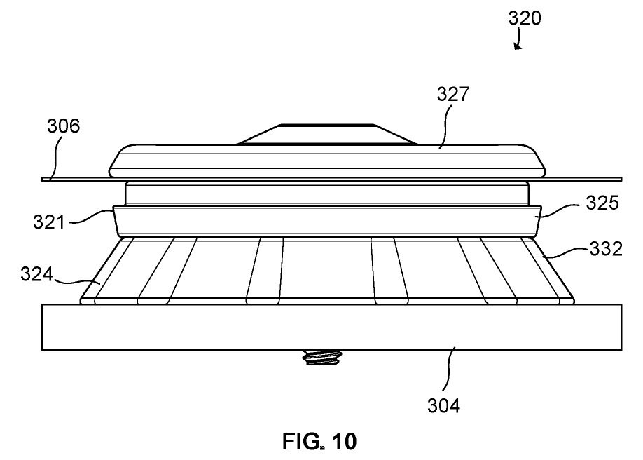

A bottom surface 325a of the first connector housing 325 can interface with a top surface 332a of the second connector housing 332 in a connected configuration (e.g., connected configuration of FIG. 10). In some embodiments, the bottom surface 325a of the first connector housing is dimensioned to engage with the top surface 332a of the second connector housing 332. In some embodiments, the first connector housing 325 can extend partially around the second connector housing 332.

The second connector 324 can include an actuator 341. The actuator 341 can extend through the second connector housing 332 and into the second connector 324 to interface with the activation surface 326. The actuator 341 is configured to translate between engaged and unengaged positions, which facilitate the release of the clamp flange 323 from the clamp 330 (see e.g., FIGS. 12A-D).

Referring to FIGS. 12A-D, the second connector 324 can be operated between an unlocked position (e.g., FIGS. 12A and 12C) a locked position (e.g., FIGS. 12B and 12D). The first connector 321 is removed from view so the operation of the second connector 324 is visible. The second connector 324 can interface with the first connector 321 to connect the mattress and the foundation.

In some embodiments, the second connector 324 moves between the unlocked position and the locked position responsive to forces applied at the activation surface 326 and the actuator 341. For example, FIGS. 12A and 12C illustrate an unlocked or armed position where the second connector 324 is prepared to receive the first connector 321 and the clamp flange 323. FIGS. 12B and 12D illustrate a locked position where the second connector 324 receives and engages with the first connector 321 and the clamp flange 323.

Referring to FIGS. 12A-D and 13, the actuator 341 is connected to an actuator plate 362 that extends below the second connector plate 333, the first and second clamp arms 330a, 330b, the magnet 334, and the activation surface 326. The actuator plate 362 is configured to move between the locked and unlocked positions. In some embodiments, the position of the actuator plate 362 controls the position of the clamp 330. In some embodiments, the actuator plate 362 moves responsive to at least one of the activation surface 326 and the actuator 341.

In some embodiments, the actuator plate 362 includes an activation cavity 364 that is positioned around the activation surface 326 and activation wings 366. The activation cavity 364 of the actuator plate 362 includes flanges 368 positioned at an interior side of the activation cavity 364. The flanges 368 extend into the activation cavity 364 to define a smaller opening between the flanges 368 than the opening across the outer portion of the activation cavity 364. A distance between the flanges 368 can be smaller than a width of the wings 366 of the activation surface 326. The wings 366 of the activation surface 326 can be positioned below the activation surface 326 and are configured to engage with the actuator plate 362 and the flanges 368 within the activation cavity 364. In the armed position of FIGS. 12A and 12C, the wings 366 are restricted from movement inward (e.g., further towards a center of the second connector 324) by contact with the flanges 368. In the locked position of FIGS. 12B and 12D, the activation surface 326 is actuated downward (e.g., by a force 370 imparted by the clamp flange 323). The downward actuation of the activation surface 326 translates the wings 366 below the flanges 368.

The movement of the activation surface 326 can be controlled by the actuator plate 362, which in turn controls the movement of the first and second clamp arms 330a, 330b. In some embodiments, the actuator plate 362 includes actuation pins 372a, 372b that interface with each of the first clamp arm 330a and the second clamp arm 330b, respectively. The actuation pins 372a, 372b extend vertically from the actuator plate 362 and engage with the first clamp arm 330a and the second clamp arm 330b in respective slots 374a, 374b at the base of each clam arm 330a, 330b. The slots 374a, 374b are angled with respect to the clamp arms 330a, 330b. For example, the slots 374a, 374b are oriented between 20 and 80 degrees, between 30 and 60 degrees, between 40 and 50 degrees, or around 45 degrees relative to the clamp arms 330a, 330b. The actuation pins 372a, 372b and the slots 374a, 374b facilitate a translation of the movement of the actuator plate 362 in a first direction 361 into movement of the first clamp arm 330a and the second clamp arm 330b towards each other in a second direction 363. In some embodiments, the first direction 361 and the second direction 363 are perpendicular to each other.

In some embodiments, the actuator plate 362 includes a spring assembly 376. The spring assembly 376 includes a spring 376a and a post 376b that extends through the spring 376a. The spring assembly 376 can bias the second connector 324 into the armed position (e.g., armed position in FIGS. 12A and 12C). For example, during a disassembly process where the mattress and foundation are being separated, the second connector 324 and the first connector 321 can disconnect from each other. In response, the spring assembly 376 biases the actuator plate 362 into the armed position so that the second connector 324 is prepared to receive the first connector 321.

The actuator plate 362 can facilitate movement of the second connector 324 between the armed or unlocked position shown in FIGS. 12A and 12C and the locked or engaged position shown in FIGS. 12B and 12D. In the armed position, the activation surface 326 is not pressed downward, and extends from the second connector plate 333. In some embodiments, the actuator 341 is pressed inward (e.g., via force 360) towards a center of the second connector 324 (e.g., towards the magnet 334). The actuator plate 362 presses inward and against the bias of the spring assembly 376. In the armed position, the actuator plate 362 positions the flanges 368 interior to (i.e., closer to the magnet 334) the wings 366. In the armed position, the wings 366 of the activation surface 326 are positioned within the activation cavity 364. In the armed position, the pins 372a, 372b actuate within the slots 374a, 374b along the angled slot to pull the first and second clamp arms 330a, 330b apart.

In the locked or engaged position, the activation surface 326 is pressed downward (e.g., by contact with the clamp flange 323), and can be flush with or below the second connector plate 333. In some embodiments, the actuator 341 is pressed (e.g., by the spring assembly 376) outward away from the center of the second connector 324 (e.g., away from the magnet 334). The wings 366 are actuated downward with the activation surface 326 such that the wings 366 are positioned below the flanges 368. The actuator plate 362 positions the flanges 368 above the wings 366. The pins 372a, 372b actuate within the slots 374a, 374b along the angled slot to pull the first and second clamp arms 330a, 330b together (e.g., along second direction 363). In the locked or engaged position, the arcuate flanges 336a, 336b close around the clamp flange 323 to hold the first connector 321 and the second connector 324 together.

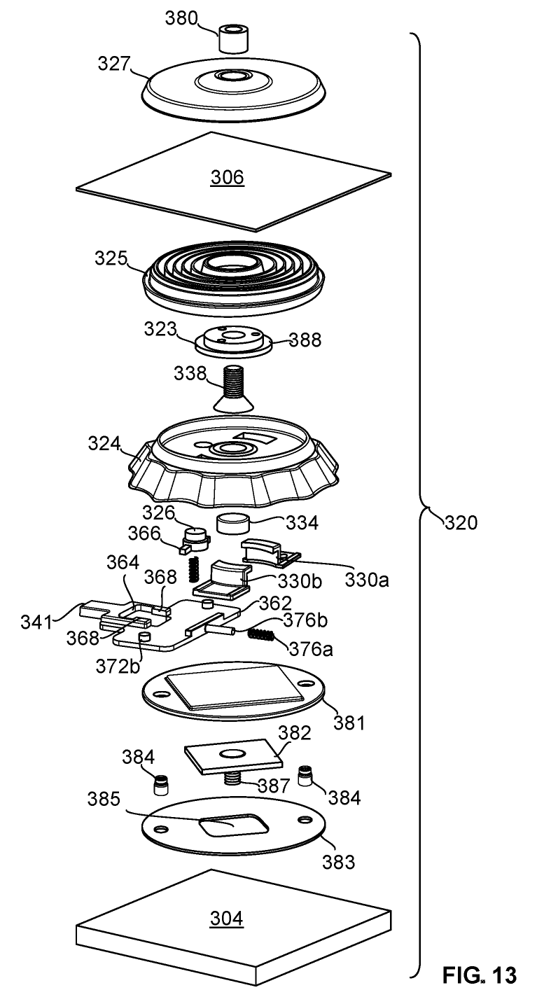

Referring to FIG. 13, the connector assembly 320 is illustrated in an exploded view. The connector assembly 320 includes the first connector and the second connector, which can connect to each other. In some embodiments, the magnet guide 338 can be a fastener that extends through the clamp flange 323 to connect the clamp flange 323 to the first connector housing 325. For example, the magnet guide 338 can connect to an upper housing insert 380 (e.g., a threaded insert) to connect the first connector together.

The second connector 324 includes a connector plate 381 positioned below the actuator plate 362. The connector plate 381 connects to a backing plate 383. The connector plate 381 receives a floating mounting plate 382 between the connector plate 381 and the backing plate 383. The floating mounting plate 382 can facilitate limited translational movement of the mounting plate 382 below the connector plate 381. The limited movement can be facilitated by a mounting opening 385 in the backing plate 383 where a center fastener 387 of the floating mounting plate 382 extends through the mounting opening 385 to connect to the foundation 304. Fasteners 384 can connect the connector plate 381 and the backing plate 383.

Referring to FIG. 14, the connector assembly 320 is shown in the locked or engaged position. In the locked position, the first clamp arm 330a and the second clamp arm 330b are actuated inwards towards each other. The clamp flange 323 is captured between the first clamp arm 330a and second clamp arm 330b. The arcuate flanges 336a, 336b extend above a clamp flange rim 388 to restrict translation of the first connector 321 away from the second connector 324. The arcuate flanges 336a, 336b extend inwardly from each of the first and second clamp arms 330a, 330b to hang over and engage with the clamp flange rim 388 and restrict or limit the movement of the first connector 321 in the engaged position.

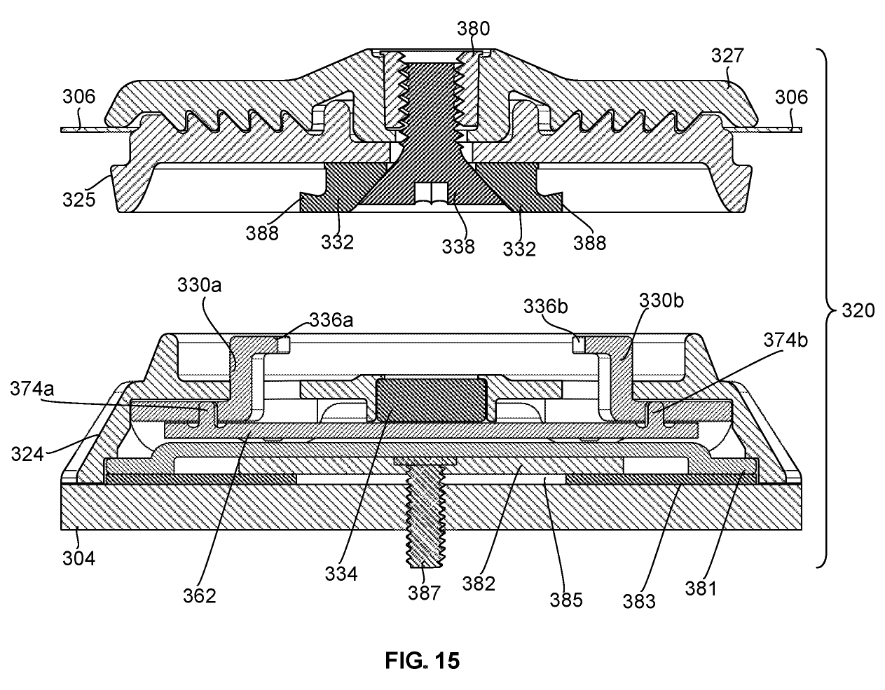

Referring to FIG. 15, the connector assembly 320 is shown in an unlocked position with the first connector 321 separated from the second connector 324.

A number of aspects/implementations of the inventions have been described. Nevertheless, it will be understood that various modifications can be made without departing from the spirit and scope of the invention. For example, in some implementations the first connector 321 and second connector 324 can include components of different sizes, shapes, and orientations. Additionally, different features of different implementations of one of the implementations the bed 112 and mattresses 302, can be combined with other features of one or more other implementations of the foundation 304 as suitable for the application. Additionally, different features of different implementations of one of the implementations the foundation 304 can be combined with other features of one or more other implementations of mattress 302, as suitable for the application. Accordingly, other implementations are within the scope of the following claims.

What is claimed is:

1. A bed system comprising:
a foundation;
a mattress configured to be positioned on top of the foundation;
a mattress attachment mechanism configured to connect the mattress to the foundation, the mattress attachment mechanism comprising:
a first connector connected to the mattress and including a clamp flange;
a second connector connected to the foundation and including a clamp and a clamp actuator, the clamp actuator selectively moves the clamp between an unlocked position and a locked position;
wherein the clamp receives the clamp flange when the clamp is in the unlocked position and, responsive to the clamp flange actuating a portion of the clamp actuator, the clamp actuator moves the clamp from the unlocked position to the locked position where the clamp engages with the clamp flange.

2. The bed system of claim 1, wherein the clamp comprises a first clamp arm and a second clamp arm that actuate towards each other when the clamp moves from the unlocked position to the locked position.

3. The bed system of claim 2, wherein the clamp flange is positioned between the first clamp arm and the second clamp arm when the clamp engages with the clamp flange.

4. The bed system of claim 2, wherein the first clamp arm includes a first arcuate flange, and the second clamp arm includes a second arcuate flange, the first and second arcuate flanges extend inwardly towards a center of the second connector.

5. The bed system of claim 4, wherein the clamp flange includes an insert flange that extends outwardly from a circumference of the clamp flange.

6. The bed system of claim 5, wherein, in the locked position, the first arcuate flange and second arcuate flange engage with the insert flange.

7. The bed system of claim 1, wherein the first connector includes a magnet guide and the second connector includes a magnet, the magnet guide and the magnet facilitate alignment between the clamp flange and the clamp.

8. The bed system of claim 1, wherein the clamp actuator includes an activation surface that is connected to an activation plate, wherein, responsive to an activation force at the activation surface, the activation surface actuates the activation plate to move the clamp from the unlocked position to the locked position.

9. The bed system of claim 8, wherein the clamp comprises a first clamp arm and a second clamp arm, the first clamp arm includes a first arm base that includes a first actuation slot, the second clamp arm includes a second arm base that includes a second actuation slot.

10. The bed system of claim 9, wherein the activation plate includes a first actuation pin positioned in the first actuation slot, and a second actuation pin positioned in the second actuation slot.

11. The bed system of claim 10, wherein, responsive to actuation of the activation plate, the first actuation pin and the second actuation pin move within the first and second actuation slots to control the position of the first and second clamp arms.

12. The bed system of claim 1, wherein the first connector includes a first connector housing and the second connector includes a second connector housing, wherein, in the locked position, the first connector housing extends at least partially around the second connector housing.

13. The bed system of claim 12, wherein the first connector housing extends beyond a bottom surface of the mattress.

14. The bed system of claim 1, wherein the foundation comprises an adjustable foundation configured for raising both a head and foot of the mattress when the adjustable foundation is actuated.

15. The bed system of claim 14, wherein the mattress attachment mechanism retains the mattress on the adjustable foundation during articulation of the adjustable foundation.

16. The bed system of claim 1, wherein the foundation comprises a first articulable panel and a second articulable panel, the mattress attachment mechanism is positioned at a joint between the first and second panels.

17. A method of assembling a bed system comprising:
positioning a mattress on a foundation, the mattress having a first connector, and the foundation having a second connector at the foundation and configured to engage the first connector;
receiving a clamp flange of one of the first connector or second connector in a clamp of the other of the first connector or the second connector;
actuating the clamp from an unlocked position to a locked position around the clamp flange.

18. The method of claim 17, wherein the mattress comprises a plurality of first connectors and the foundation comprises a plurality of second connectors that are configured to engage with each other.

19. The method of claim 17, wherein the clamp is actuated responsive to the clamp flange engaging with an activation surface of the second connector.

20. The method of claim 17, wherein, in the locked position, the clamp engages with the clamp flange to restrict movement of the mattress away from the foundation.
